(19) United States
(12) Patent Application Publication
(10) Pub. No.: US 2014/0095565 A1
(43) Pub. Date: Apr. 3, 2014

(54) Constrained Grid-Based Filter

(71) Applicant: Mark Eric Silbert, Great Mills, MD (US)

(72) Inventor: Mark Eric Silbert, Great Mills, MD (US)

(73) Assignee: United States of America as represented by the Secretary of the Navy, Patuxent River, MD (US)

(21) Appl. No.: 14/044,008

(22) Filed: Oct. 2, 2013

Related U.S. Application Data
(60) Provisional application No. 61/708,673, filed on Oct. 2, 2012.

(51) Int. Cl. G06F 17/10

(52) U.S. Cl. CPC G06F 17/10
USPC 708/308

(57) ABSTRACT

A constrained four dimensional grid-based filter (CGBF) used to provide state estimates for a target maneuvering in two dimensions. Optimal grid and sampling sizes or chosen and the kinematic constraints of the target a y used to restrict the possible predicted states resulting in quality target estimates.

### CROSS-REFERENCE TO RELATED APPLICATIONS

This application claims the benefit of priority from U.S. Provisional Patent Application Ser. No. 61/708,673, filed on Oct. 2, 2012.

### STATEMENT OF GOVERNMENT INTEREST

The invention described herein may be manufactured and used by or for the Government of the United States of America for governmental purposes without payment of any royalties thereon or therefore.

### BACKGROUND

The present invention relates to an improved system for using a grid based filter to track a maneuvering target. More specifically, but without limitation, the present invention is a constrained multi-dimensional grid based filter used to provide state estimates for a maneuvering target.

Over the years, many systems have been developed to address the target tracking problem. However, tracking multiple maneuvering targets, as shown, in FIG. 1, remains a notable weakness of these systems. At the heart of a tracking system is the target track filter. The track filter computes the most likely target state given all the measurements collected on that target. This most likely state is typically based on the one that minimizes the mean squared error (MSE). In the early 1960s, Rudolf Kalman published a paper entitled “New Approach to Linear Filtering and Prediction Problems.” (Transactions of the ASME—Journal of Basic Engineering, 82 (Series D): 35-45.) Kalman described a filter that yields minimum MSE state estimates for systems that exhibit linear dynamics. This filter became known as the Kalman filter and since its debut, it has been extensively studied and has emerged as the premier method for target track filtering due to its computational efficiency and its filtering effectiveness.

The Kalman filter is now used in many applications from GPS tracking to air traffic control. If the motion is linear and the measurement errors are Gaussian, a Kalman filter can provide accurate estimates of a target state efficiently.

Nevertheless, although the Kalman filter is efficient and effective for computing state estimates of a moving target, it produces poor estimates when tracking a maneuvering target. The reason for these poor estimates is that the Kalman filter is a linear filter. It assumes the dynamics of the tracked target can be modeled as a linear system, but maneuvering targets do not generally exhibit linear motion. The reason the target motion needs to be linear is due to a property of the normal distribution. A normal random variable remains normal through a linear transform. If the transform is not linear, there is no guarantee that the normal variable will remain normal.

The Kalman filter includes a process noise parameter which provides a means to capture the uncertainty in the target motion. Thus, a straightforward way to allow the Kalman filter to track maneuvering targets would be to simply employ a large process noise. The idea is to treat the non-linear target motion simply as a larger uncertainty in its linear motion. However, increasing the process noise parameter causes large errors in the computed state estimates. These larger errors cause more ambiguity making the tracking process more difficult.

Since the Kalman filter was so effective for linear targets, researchers began looking for enhancements and/or extensions to the Kalman filter. One of the early extensions was the extended Kalman filter (EKF). Radar was (and still is) the dominant sensor used for target tracking. One of the early refinements to radar systems was the ability to measure the closing rate of the target. This closing rate is known as the range rate. Actually, the range rate is a closing rate only when the target is moving radially towards, or away from the radar. If the target is moving along some other path, the range rate is measuring only that component of the target's velocity that is moving radially towards (or away from) the radar. This radial component is proportional to the cosine of the difference of the angles between the target's course and the radial angle from the target to the radar. This radial angle to the target is often called the azimuth angle. Cosine is a non-linear function and since the range rate is a function of cosine, the (linear) Kalman filter had to be extended to address this non-linear quantity. The resulting Extended Kalman Filter (EKF), includes this range rate measurement into the calculations by performing a first-order approximation of its additional information. Since the Kalman filter is inherently a linear filter, the intent is to linearize the range rate information. However, the cosine cannot always be estimated well with only a first-order approximation, so the EKF is a suboptimal filter. As a result, an EKF will at times perform no better than a Kalman filter and could even perform worse by failing to properly track the target.

Several other extensions to the Kalman filter subsequently emerged including iterated extended Kalman filters (IEKF), unscented Kalman filters (UKFs), and interacting motion model Kalman filters (IMMs). All these methods have the advantage that they are based on the Kalman filter and have closed-form solutions. This makes them computationally efficient and well-grounded in a mathematical formulization. However, all these methods make assumptions about the maneuvering target that are often not true, which leads to erroneous estimates.

Vast improvements to radar, computers and computational power have led researchers to pursue more numerical (and thus, more computational) methods for target tracking. Two methods that emerged were grid-based filters (GBFs) and particle filters (PFs). These methods were broadly classified as sequential Monte Carlo (SMC) techniques. A key feature of these methods is that they allow many of the restricted assumptions placed on the closed-form methods to be relaxed. It then became possible to consider more general, non-linear target dynamics. Any presumed motion of the target could be modeled without being limited to linear dynamics. In addition, the measurement errors could be modeled more realistically, unlike the Kalman filter-like methods, which assume Gaussian error on the measurements even though radar measurements are generally not Gaussian (at least not in rectilinear space).

The idea behind a GBF is to first discretize the region where the targets are presumed to reside into a set of cells. The next step is to model how the targets would transition from cell to cell over time. Finally, measurements are used to increase the probability of the target being in a cell. Unfortunately, even with faster computers, this approach is far too computational to execute in real-time. Although the grid-based filter approach is an attractive solution, due to its computational burden, it is difficult to implement and, thus, has not gained widespread use. What is needed is a computationally economical method capable of using a four dimensional grid based filter for tracking a target maneuvering in two dimensions.

### SUMMARY

The present invention is directed to a multi-dimensional grid based filter for tracking a moving target. The filter provides state estimates for a maneuvering target using a grid-based filter by initially forming a first grid of cells to capture an initial target state comprising an estimate of the target's position, course and speed using a first measurement. A second grid of cells, of a finite size and scale, is formed wherein each cell comprises possible estimated states to which the target could have transitioned over a time between the first and a second measurement. Using a sampling technique, the prediction distribution is estimated for each cell in the grid using the various maneuvering probabilities of the target. Each cell corresponds to a particular rectangular region in an x and y coordinate plane. An initial estimate is made of the probability that the target is in the corresponding rectangular region. There is also an estimate of the expected initial speed of the target and the variance of the speed in the corresponding rectangular region. Similarly, there is an estimate of the expected initial course of the target and the variance of the course in the corresponding rectangular region. A discretized probability distribution over all the cells in the second grid is formed using Monte Carlo sampling. The position distribution is assumed to be uniformly distributed over the cell and each cell forms a normal distribution for the possible speeds for that region. Also, each cell forms a normal distribution of the possible courses for that region. This process repeats for each measurement update where the second grid becomes the first grid for the next update.

### DRAWINGS

These and other features, aspects and advantages of the present invention will become better understood with reference to the following description and appended claims, and accompanying drawings wherein:

FIG. 1 is a picture of an aircraft tracking various surface targets via radar.

FIG. 2 is an algorithm for computing the destination grid (i.e., the second grid) for each update.

FIG. 3 is a graph of true predicted positional containment region.

FIG. 4 is a table comparing the Constrained Grid-Based Filter predicted state and covariance to the Kalman Filter as the maximum turn a of the target is varied.

FIG. 5 is an illustration showing the grid cell update using Monte Carlo sampling.

FIG. 6 is a graph shoving the target motion symmetry, mirrored state calculation.

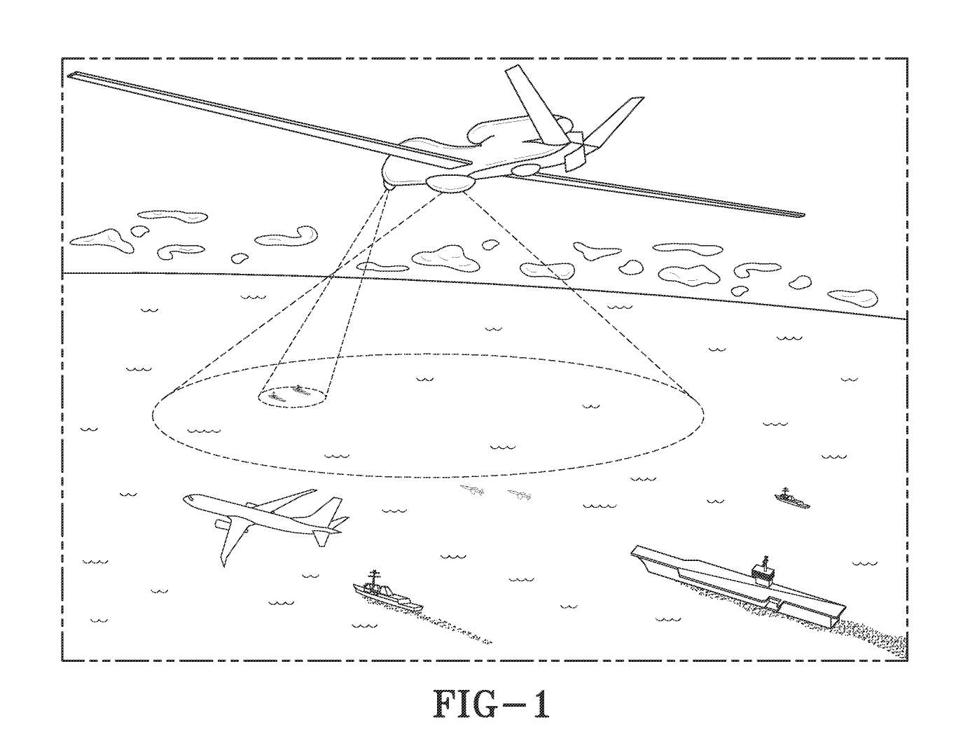

### DESCRIPTION

In the following description of the present invention, reference will be made to various embodiments which are not meant to be all inclusive. The current invention can be implemented using various forms of software for execution on a variety of computer systems. The preferred embodiments of the present invention are illustrated by way of example below and in the referenced Figures.

The power of a grid based filter (GBF) can be exploited with two-dimensional grid. The solution assumes that the grid discretizes the x,y locations, and then extends what is stored in each cell of the grid. Instead of merely storing the probability of the target being at a given x,y location, four other values are also included: 1) the expected speed of the target given it is at that location, 2) the variance of speeds of the target at that location 3) the expected course of the target at the given location and 4) the variance of the targets expected course at the given location.

Because the kinematic constraints on a target are usually specified in terms of speeds and turn rates, these values are used instead of component velocities. This ensures that the targets kinematic constraints are enforced and exploited in the analysis. It is not necessary to store the velocity as speed and course. It could be stored as x and y velocity components. The purpose of storing the course and speed is to more easily and directly exploit the speed, acceleration, and turn rate constraints of the target. However, it should be noted that working with course angle brings up different computation difficulties due to its circular nature.

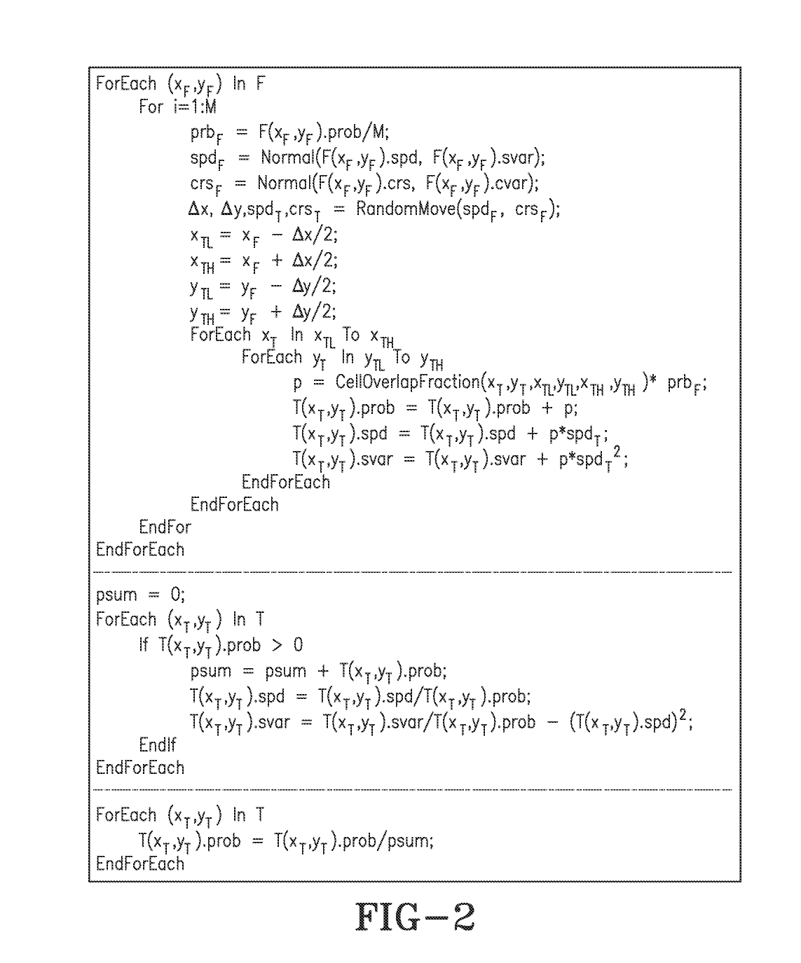

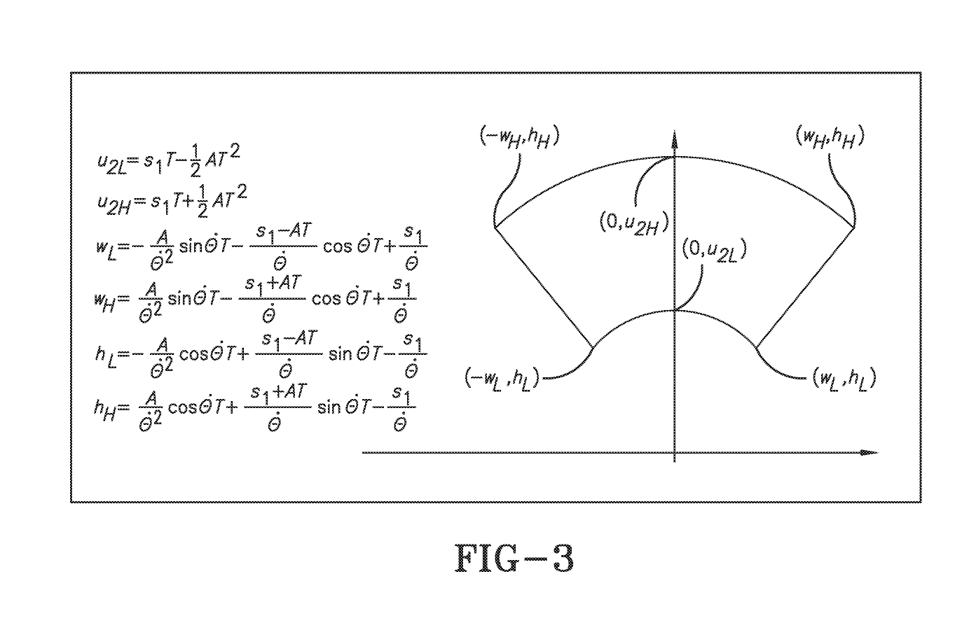

There are two grids, an originating grid and a destination grid. These grids can be thought of as the From and To grids. Let the From grid be labeled F and the To grid be labeled T. Then F(x,y) is the cell at location x,y in the From grid. ‘Dot notation’ will be used to select each of the five values within a cell where F(x,y).prob, F(x,y).spd, F(x,y).svar, F(x,y).crs, and F(x,y).cvar are the probability, mean speed, speed variance, mean course, and course variance, respectively. The algorithm in FIG. 2 shows how the probability, mean speed and speed variance values are computed. The computation of the mean course and its variance require additional steps to deal with the circular nature of the course parameter, but are not further described.

There are three separate loops in FIG. 2. The first loop forms the weighted sums (probability) based on Monte Carlo samples. It is also the loop that determines to which track a new measurement should be assigned in multi-target scenarios. The measurement would be assigned to the grid which yields the highest cumulative probability. After the sampling is complete, the second loop converts these weighted sums into mean and variance, using the equations 1-3 shown below. The final loop re-normalizes the mass in the cells.

$$\begin{matrix}P = \sum {p}_{i} & Eq . 1 \\ \overline{s} = \frac{1}{P} \sum {p}_{i} {s}_{i} & Eq . 2 \\ {σ}_{s}^{2} = \frac{1}{P} \sum {p}_{i} {s}_{i}^{2} - {( \overline{s} )}^{2} & Eq . 3\end{matrix}$$

### The 2D Target Motion Model

The algorithm in FIG. 2 also references three external functions: Normal, RandomMove, and CellOverlapFunction. The ‘Normal’ function creates normally distributed random variables. The RandomMove function creates random, but kinematically feasible predicted states over the time interval. The function allows any target motion model to be used for a CGBF. The motion model can be developed as follows. Assume that a target maneuvers at times tₖ, k=1, 2, 3, . . . These times are independent of the measurement update times and are within an update interval. At each time tₖ, the target undergoes a constant acceleration and/or constant turn maneuver that persists until the next maneuver time. Assume, at time tₖ₋₁, the target is at location (xₖ₋₁, yₖ₋₁) with speed and course, sₖ₋₁, θₖ₋₁, respectively. Let \dot{s} be a (randomly) selected acceleration (along the direction of travel) and \dot{θ} be a (randomly) selected turn rate that the target will undergo for the duration of the next movement. Let τ=tₖ−tₖ₋₁ be the duration of the next maneuver. Then the target state as a function of time over the interval 0 to τ would be defined by the equations below:

$$\begin{matrix}s ( t ) = {s}_{k - 1} + \dot{s} t & Eq . 4 \\ θ ( t ) = {θ}_{k - 1} + {\dot{θ}}_{t} & Eq . 5 \\ \dot{x} ( t ) = s ( t ) sin θ ( t ) & Eq . 6 \\ \dot{y} ( t ) = s ( t ) cos θ ( t ) & Eq . 7 \\ \begin{matrix}x ( t ) = {x}_{k - 1} + {\int }_{0}^{t} \dot{x} ( t ) d t \\ = {x}_{k - 1} + \frac{1}{{\dot{θ}}^{2}} [ \dot{s} sin θ ( t ) - s ( t ) \dot{θ} cos θ ( t ) ] {\vert}_{0}^{t} \\ = {x}_{k - 1} + \frac{1}{{\dot{θ}}^{2}} [ \begin{matrix}\dot{s} sin θ ( t ) - s ( t ) \dot{θ} cos θ ( t ) - \\ \dot{s} sin {θ}_{k - 1} + {s}_{k - 1} \dot{θ} cos {θ}_{k - 1}\end{matrix} ]\end{matrix} & Eq . 8 \\ \begin{matrix}y ( t ) = {y}_{k - 1} + {\int }_{0}^{t} \dot{y} ( t ) d t \\ = {y}_{k - 1} + \frac{1}{{\dot{θ}}^{2}} [ \dot{s} cos θ ( t ) + s ( t ) \dot{θ} sin θ ( t ) ] {\vert}_{0}^{t} \\ = {y}_{k - 1} + \frac{1}{{\dot{θ}}^{2}} [ \begin{matrix}\dot{s} cos θ ( t ) + s ( t ) \dot{θ} sin θ ( t ) - \\ \dot{s} cos {θ}_{k - 1} - {s}_{k - 1} \dot{θ} sin {θ}_{k - 1}\end{matrix} ]\end{matrix} & Eq . 9\end{matrix}$$

Even though the motion equations are mathematically sound, there could be computational problems when the maximum turn rate is (nearly) zero. To avoid these problems, let ε_{θ}>0 be the smallest turn rate value at which smaller values are equivalent to the larger moving along a constant straight line course. Then the equations 8 and 9 become.

$$\begin{matrix}x ( t ) = {x}_{k - 1} + \{ \begin{matrix}\frac{1}{{\dot{θ}}^{2}} [ \begin{matrix}\dot{s} sin θ ( t ) - s ( t ) \dot{θ} cos θ ( t ) - \\ \dot{s} sin {θ}_{k - 1} + {s}_{k - 1} \dot{θ} cos {θ}_{k - 1}\end{matrix} ] & if \vert \dot{θ} \vert > {ε}_{\dot{θ}} \\ ( {s}_{k - 1} t + \frac{1}{2} \dot{s} {t}^{2} ) sin ( {θ}_{k - 1} + {\dot{θ}}_{τ} ) & otherwise\end{matrix} & Eq . 10 \\ y ( t ) = {y}_{k - 1} + \{ \begin{matrix}\frac{1}{{\dot{θ}}^{2}} [ \begin{matrix}\dot{s} cos θ ( t ) + s ( t ) \dot{θ} sin θ ( t ) - \\ \dot{s} cos {θ}_{k - 1} - {s}_{k - 1} \dot{θ} sin {θ}_{k - 1}\end{matrix} ] & if \vert \dot{θ} \vert > {ε}_{\dot{θ}} \\ ( {s}_{k - 1} t + \frac{1}{2} \dot{s} {t}^{2} ) cos ( {θ}_{k - 1} + {\dot{θ}}_{τ} ) & otherwise\end{matrix} & Eq . 11\end{matrix}$$

### The Mean and Variance of the Transition Density (Single Maneuver)

Assume there is only one maneuver over the update time interval, i.e., T=τ. Thus, the maneuver duration, τ, will be used to emphasize this fact. Refer to equations 4-9. The state at the end of the maneuver is found using t=τ. Recall that the subscript k refers to the (true) state of the target after the k^{th} maneuver within an update time interval. A subscript of zero is the true state of the target at the beginning of the time interval. So:

$$\begin{matrix} {s}_{1} = s ( τ ) = {s}_{0} + \dot{s} τ & Eq . 12 \\ {θ}_{1} = θ ( τ ) = {θ}_{0} + \dot{θ} τ & Eq . 13 \\ {\dot{x}}_{1} = \dot{x} ( τ ) = s ( τ ) sin θ ( τ ) = {s}_{1} sin {θ}_{1} & Eq . 14 \\ {\dot{y}}_{1} = \dot{y} ( τ ) = s ( τ ) cos θ ( τ ) = {s}_{1} cos {θ}_{1} & Eq . 15 \\ {x}_{1} = x ( τ ) = {x}_{0} + \frac{1}{{\dot{θ}}^{2}} [ \dot{s} sin {θ}_{1} - {s}_{1} \dot{θ} cos {θ}_{1} - \dot{s} sin {θ}_{0} + {s}_{0} \dot{θ} cos {θ}_{0} ] & Eq . 16 \\ {y}_{1} = y ( τ ) = {y}_{0} + \frac{1}{{\dot{θ}}^{2}} [ \dot{s} cos {θ}_{1} + {s}_{1} \dot{θ} sin {θ}_{1} - \dot{s} cos {θ}_{0} - {s}_{0} \dot{θ} sin {θ}_{0} ] & Eq . 17\end{matrix}$$

### The Mean Variance of the Speed and Course

The mean and variance of the speed and course is determined using the equations below:

s₁=s(τ)=s₀+\dot{s}τ and θ₁=θ(τ)=θ₀+\dot{θ}τ Eq. 18

E[s₁]=E[s₀+\dot{s}τ]=E[s₀]+E[\dot{s}τ]=E[s₀]+τE[\dot{s}]=s₀ Eq. 19

And similarly from equations 13,

E[θ₁]=E[θₒ+\dot{θ}τ]=E[θ₀]+τE[\dot{θ}]=θ₀ Eq. 20

The expected speed and course after the target maneuvers are identical to what they were prior to the maneuver. Calculation of the variances for the speed and course are calculated as follows:

Var[s₁]=Var[s₀+\dot{s}τ]=Var[s₀]+Var[\dot{s}τ]=Var[s₀]+τ²Var[\dot{s}]=τ²σₛ² Eq. 21

Var[θ₁]=Var[θ₀+\dot{θ}τ]=Var[θ₀]+τ²Var[\dot{θ}]=τ²σ_{θ}² Eq. 22

The selection of accelerations and turn rates were picked from a uniform distribution over the range of possible rates. As a result,

$${σ}_{\dot{s}}^{2} = \frac{{( 2 A )}^{2}}{12} = \frac{{A}^{2}}{3} and {σ}_{\dot{θ}}^{2} = \frac{{( 2 \dot{Θ} )}^{2}}{12} = \frac{{\dot{Θ}}^{2}}{3} ,$$

where A is the maximum acceleration and \dot{Θ} is the maximum turn rate. The variance of the velocity is quadratic with respect to time, or equivalently, the standard deviation of the velocity is linear in time.

### Mean and Variance of the Component Velocities

The mean and variance of the component velocities can also be determined. In doing so, assume the distribution is in polar space and the acceleration change is independent of the course change. Therefore, the following calculations are used.

E[\dot{x}₁]=E[s₁ sin θ₁] Eq. 23

E[\dot{y}₁]=E[s₁ cos θ₁] Eq. 24

Since it is assumed that the acceleration change is independent of the course change,

E[\dot{x}₁]=E[s₁ sin θ₁]=E[s₁]E[sin θ₁] Eq. 25

E[\dot{y}₁]=E[s₁ cos θ₁]=E[s₁]E[cos θ₁] Eq. 26

the E[s₁] was already found in equation 19. Using the properties of sine and cosine,

$$\begin{matrix}\begin{matrix}E [ sin {θ}_{1} ] = E [ sin ( {θ}_{0} + \dot{θ} τ ) ] \\ = E [ sin {θ}_{0} cos \dot{θ} τ + sin \dot{θ} τcos {θ}_{0} ] \\ = sin {θ}_{0} E [ cos \dot{θ} τ ] + cos {θ}_{0} E [ sin \dot{θ} τ ]\end{matrix} & Eq . 27 \\ \begin{matrix}E [ cos {θ}_{1} ] = E [ cos ( {θ}_{0} + \dot{θ} τ ) ] \\ = E [ cos {θ}_{0} cos \dot{θ} τ - sin {θ}_{0} sin \dot{θ} τ ] \\ = cos {θ}_{0} E [ cos \dot{θ} τ ] - sin {θ}_{0} E [ sin \dot{θ} τ ]\end{matrix} & Eq . 28\end{matrix}$$

The remaining expected values can be found using the definition of expected value. Assume, as before, that \dot{θ} is a uniform random variable on the interval [−\dot{Θ}, +\dot{Θ}]. Therefore,

$$\begin{matrix}\begin{matrix}E [ sin \dot{θ} τ ] = {\int }_{- \dot{Θ}}^{+ \dot{Θ}} ( \frac{1}{2 \dot{Θ}} ) sin \dot{θ} τ d \dot{θ} \\ = - ( \frac{1}{2 \dot{Θ} τ} ) cos \dot{θ} τ {\vert}_{- \dot{Θ}}^{+ \dot{Θ}} \\ = - ( \frac{1}{2 \dot{Θτ}} ) ( cos \dot{Θ} τ - cos \dot{Θ} τ ) \\ = 0\end{matrix} & Eq . 29 \\ \begin{matrix}E [ cos \dot{θ} τ ] = {\int }_{- \dot{Θ}}^{+ \dot{Θ}} ( \frac{1}{2 \dot{Θ}} ) cos \dot{θ} τ d \dot{θ} \\ = ( \frac{1}{2 \dot{Θ} τ} ) sin \dot{θ} τ {\vert}_{- \dot{Θ}}^{+ \dot{Θ}} \\ = ( \frac{1}{2 \dot{Θτ}} ) ( sin \dot{Θ} τ + sin \dot{Θ} τ ) \\ = \frac{sin \dot{Θ} τ}{\dot{Θ} τ}\end{matrix} \\ Thus , & Eq . 30 \\ E [ sin {θ}_{1} ] = sin {θ}_{0} \frac{sin \dot{Θ} τ}{\dot{Θ} τ} & Eq . 31 \\ E [ cos {θ}_{1} ] = cos {θ}_{0} \frac{sin \dot{Θ} τ}{\dot{Θ} τ} & Eq . 32\end{matrix}$$

From equations 27, 28, 29, 31, and 32,

$$\begin{matrix}E [ {\dot{x}}_{1} ] = {s}_{0} sin {θ}_{0} \frac{sin \dot{Θ} τ}{\dot{Θ} τ} & Eq . 33 \\ E [ {\dot{y}}_{1} ] = {s}_{0} cos {θ}_{0} \frac{sin \dot{Θ} τ}{\dot{Θ} τ} & Eq . 34\end{matrix}$$

Where \dot{Θ}τ is small,

$$\frac{sin \dot{Θ} τ}{\dot{Θ} τ} \approx 1.$$

The variances of the component velocities can now be found.

Var[X]=E[X²]−(E[X])² Eq. 35

Thus, from equations 27, 28, 33, 34,

$$\begin{matrix}Var [ {\dot{x}}_{1} ] = E [ {\dot{x}}_{1}^{2} ] - {( E [ {\dot{x}}_{1} ] )}^{2} = E [ {s}_{1}^{2} ] E [ {sin}^{2} {θ}_{1} ] - {( {s}_{0} sin {θ}_{0} \frac{sin \dot{Θ} τ}{\dot{Θ} τ} )}^{2} & Eq . 36 \\ Var [ {\dot{y}}_{1} ] = E [ {\dot{y}}_{1}^{2} ] - {( E [ {\dot{y}}_{1} ] )}^{2} = E [ {s}_{1}^{2} ] E [ {cos}^{2} {θ}_{1} ] - {( {s}_{0} cos {θ}_{0} \frac{sin \dot{Θ} τ}{\dot{Θ} τ} )}^{2} & Eq . 37\end{matrix}$$

Using equation E[s₁²]=Var[s₁]+(E[s₁])², so from equation 19 and 21,

E[s₁²]=τ²σₛ²+s₀² Eq. 38

E[sin² θ₁], and E[cos² θ₁] can be found using the definition of expected value and Wolfram Mathematica Online Integrator.

$$\begin{matrix}\begin{matrix}E [ {sin}^{2} {θ}_{1} ] = {\int }_{- \dot{Θ}}^{+ \dot{Θ}} ( \frac{1}{2 \dot{Θ}} ) {sin}^{2} ( {θ}_{0} + \dot{θ} τ ) d \dot{θ} \\ = \frac{2 ( {θ}_{0} + \dot{θ} τ ) - sin 2 ( {θ}_{0} + \dot{θ} τ )}{8 \dot{Θ} τ} {\vert}_{- \dot{Θ}}^{+ \dot{Θ}} \\ = \frac{\begin{matrix}2 ( {θ}_{0} + \dot{Θ} τ ) - sin 2 ( {θ}_{0} + \dot{Θ} τ ) - 2 ( {θ}_{0} - \dot{Θ} τ ) + \\ sin 2 ( {θ}_{0} - \dot{Θ} τ )\end{matrix}}{8 \dot{Θ} τ} \\ = \frac{1}{8 \dot{Θ} τ} [ 4 \dot{Θ} τ - sin 2 ( {θ}_{0} + \dot{Θ} τ ) + sin 2 ( {θ}_{0} - \dot{Θ} τ ) ] \\ = \frac{1}{2} + \frac{\begin{matrix}- sin 2 {θ}_{0} cos 2 \dot{Θ} τ - cos 2 {θ}_{0} sin 2 \dot{Θ} τ + \\ sin 2 {θ}_{0} cos 2 \dot{Θ} τ - cos 2 {θ}_{0} sin 2 \dot{Θ} τ\end{matrix}}{8 \dot{Θ} τ} \\ = \frac{1}{2} - \frac{cos 2 {θ}_{0} sin 2 \dot{Θ} τ}{4 \dot{Θτ}} \\ = \frac{1}{2} ( 1 - \frac{sin 2 \dot{Θ} τ}{2 \dot{Θ} τ} cos 2 {θ}_{0} )\end{matrix} & Eq . 39 \\ \begin{matrix}E [ {cos}^{2} {θ}_{1} ] = {\int }_{- \dot{Θ}}^{+ \dot{Θ}} ( \frac{1}{2 \dot{Θ}} ) {cos}^{2} ( {θ}_{0} + \dot{θ} τ ) d \dot{θ} \\ = \frac{2 ( {θ}_{0} + \dot{θ} τ ) + sin 2 ( {θ}_{0} + \dot{θ} τ )}{8 \dot{Θ} τ} {\vert}_{- \dot{Θ}}^{+ \dot{Θ}} \\ = \frac{[ \begin{matrix}2 ( {θ}_{0} + \dot{Θ} τ ) + sin 2 ( {θ}_{0} + \dot{Θ} τ ) - 2 ( {θ}_{0} - \dot{Θ} τ ) - \\ sin 2 ( {θ}_{0} - \dot{Θ} τ )\end{matrix} ]}{8 \dot{Θ} τ} \\ = \frac{1}{8 \dot{Θ} τ} [ 4 \dot{Θ} τ + sin 2 ( {θ}_{0} + \dot{Θ} τ ) - sin 2 ( {θ}_{0} - \dot{Θ} τ ) ] \\ = \frac{1}{2} + \frac{\begin{matrix}sin 2 {θ}_{0} cos 2 \dot{Θ} τ + cos 2 {θ}_{0} sin 2 \dot{Θ} τ - \\ sin 2 {θ}_{0} cos 2 \dot{Θ} τ + cos 2 {θ}_{0} sin 2 \dot{Θ} τ\end{matrix}}{8 \dot{Θ} τ} \\ = \frac{1}{2} + \frac{cos 2 {θ}_{0} sin 2 \dot{Θ} τ}{4 \dot{Θτ}} \\ = \frac{1}{2} ( 1 + \frac{sin 2 \dot{Θ} τ}{2 \dot{Θ} τ} cos 2 {θ}_{0} )\end{matrix} & Eq . 40\end{matrix}$$

Therefore, using equations 36-40,

$$\begin{matrix}Var [ {\dot{x}}_{1} ] = ( {τ}^{2} {σ}_{\dot{s}}^{2} + {s}_{0}^{2} ) ( \frac{1}{2} - \frac{cos 2 {θ}_{0} sin 2 \dot{Θ} τ}{4 \dot{Θ} τ} ) - {( {s}_{0} sin {θ}_{0} \frac{sin \dot{Θ} τ}{\dot{Θ} τ} )}^{2} & Eq . 41 \\ Var [ {\dot{y}}_{1} ] = ( {τ}^{2} {σ}_{\dot{s}}^{2} + {s}_{0}^{2} ) ( \frac{1}{2} + \frac{cos 2 {θ}_{0} sin 2 \dot{Θ} τ}{4 \dot{Θ} τ} ) - {( {s}_{0} cos {θ}_{0} \frac{sin \dot{Θ} τ}{\dot{Θ} τ} )}^{2} & Eq . 42\end{matrix}$$

These equations emphasize how different the CGBF prediction model is from the one in the Kalman filter. To gain some appreciation for these equations, consider the case when θ₀=0, i.e., the target's course is due north. Then, (41) and (42) become:

$$\begin{matrix}Var [ {\dot{x}}_{1} ] = ( {τ}^{2} {σ}_{\dot{s}}^{2} + {s}_{0}^{2} ) ( \frac{1}{2} - \frac{sin 2 \dot{Θ} τ}{4 \dot{Θτ}} ) & Eq . 43 \\ Var [ {\dot{y}}_{1} ] = ( {τ}^{2} {σ}_{\dot{s}}^{2} + {s}_{0}^{2} ) ( \frac{1}{2} + \frac{sin 2 \dot{Θ} τ}{4 \dot{Θτ}} ) - {( {s}_{0} \frac{sin \dot{Θ} τ}{\dot{Θ} τ} )}^{2} & Eq . 44\end{matrix}$$

As \dot{Θ}τ goes to zero, i.e., \dot{Θ}τ→0, the ration

$$\frac{sin \dot{Θ} τ}{\dot{Θ} τ} -> 1 ,$$

so:

$$\begin{matrix}Var [ {\dot{x}}_{1} ] -> ( {τ}^{2} {σ}_{\dot{s}}^{2} + {s}_{0}^{2} ) ( \frac{1}{2} - \frac{1}{2} ) = 0 & Eq . 45 \\ Var [ {\dot{y}}_{1} ] -> ( {τ}^{2} {σ}_{\dot{s}}^{2} + {s}_{0}^{2} ) ( \frac{1}{2} + \frac{1}{2} ) - {( {s}_{0} )}^{2} = {τ}^{2} {σ}_{\dot{s}}^{2} & Eq . 46\end{matrix}$$

The variance in the x direction should go to zero because when \dot{Θ}τ=0, the target is (only) moving exactly along its initial course, so there is no uncertainty in course. The resulting variance in the y direction (i.e., the variance in position uncertainty along the target's initial course) agrees with the process model for the Kalman filter. Thus, the CGBF uses a directional process model.

### The Mean and Variance of the Position

The mean and variance of the position can also be determined. The mean of the position is considered first. Without any loss of generality, assume the target is initially moving due north. This assumption does not limit the generality because the distribution is being computed along the initial course of the target. Thus, any other initial course is just a rotation of the mean position to align with the target's initial course. With this assumption,

θ₀=0.

The distribution must be symmetric about the initial course since the target can turn left just as easily as turning right. Since the target is assumed to have an initial course of zero, i.e., due north, the distribution must be symmetric about the y-axis. Therefore, E[x₁]=x₀. However, this result will be proven. The E[x₁] is computed from the modified position Eq. 10 and 11.

$$\begin{matrix}E [ {x}_{1} ] = E [ {x}_{0} + \{ \begin{matrix}\frac{1}{{\dot{θ}}^{2}} [ \dot{s} sin {θ}_{1} - {s}_{1} \dot{θ} cos {θ}_{1} - \dot{s} sin {θ}_{0} + {s}_{0} \dot{θ} cos {θ}_{0} ] & if \vert \dot{θ} \vert > {ε}_{\dot{θ}} \\ ( {s}_{0} τ + \frac{1}{2} \dot{s} {τ}^{2} ) sin ( {θ}_{0} + \dot{θ} τ ) & otherwise\end{matrix} ] & Eq . 47 \\ E [ {y}_{1} ] = E [ {y}_{0} + \{ \begin{matrix}\frac{1}{{\dot{θ}}^{2}} [ \dot{s} cos {θ}_{1} + {s}_{1} \dot{θ} sin {θ}_{1} - \dot{s} cos {θ}_{0} - {s}_{0} \dot{θ} sin {θ}_{0} ] & if \vert \dot{θ} \vert > {ε}_{\dot{θ}} \\ ( {s}_{0} τ + \frac{1}{2} \dot{s} {τ}^{2} ) cos ( {θ}_{0} + \dot{θ} τ ) & otherwise\end{matrix} ] & Eq . 48\end{matrix}$$

As before, assume the target is initially moving due north, so θ₀=0. With this simplification:

$$\begin{matrix}E [ {x}_{1} ] = E [ {x}_{0} + \{ \begin{matrix}\frac{1}{{\dot{θ}}^{2}} [ \dot{s} sin \dot{θ} τ - {s}_{1} \dot{θ} cos \dot{θ} τ + {s}_{0} \dot{θ} ] & if \vert \dot{θ} \vert > {ε}_{\dot{θ}} \\ ( {s}_{0} τ + \frac{1}{2} \dot{s} {τ}^{2} ) sin \dot{θ} τ & otherwise\end{matrix} ] & Eq . 49 \\ E [ {y}_{1} ] = E [ {y}_{0} + \{ \begin{matrix}\frac{1}{{\dot{θ}}^{2}} [ \dot{s} cos \dot{θ} τ + {s}_{1} \dot{θ} sin \dot{θ} τ - \dot{s} ] & if \vert \dot{θ} \vert > {ε}_{\dot{θ}} \\ ( {s}_{0} τ + \frac{1}{2} \dot{s} {τ}^{2} ) cos \dot{θ} τ & otherwise\end{matrix} ] & Eq . 50\end{matrix}$$

And again assuming \dot{s} and \dot{θ} are independent random variables,

$$\begin{matrix}E [ {x}_{1} ] = {x}_{0} + \{ \begin{matrix}E [ \dot{s} ] E [ \frac{sin \dot{θ} τ}{{\dot{θ}}^{2}} ] - E [ {s}_{1} ] E [ \frac{cos \dot{θ} τ}{\dot{θ}} ] + {s}_{0} E [ \frac{1}{\dot{θ}} ] & if \vert \dot{θ} \vert > {ε}_{\dot{θ}} \\ E [ {s}_{0} τ + \frac{1}{2} \dot{s} {τ}^{2} ] E [ sin \dot{θ} τ ] & otherwise\end{matrix} & Eq . 51 \\ E [ {y}_{1} ] = {y}_{0} + \{ \begin{matrix}E [ \dot{s} ] E [ \frac{cos \dot{θ} τ}{{\dot{θ}}^{2}} ] + E [ {s}_{1} ] E [ \frac{sin \dot{θ} τ}{\dot{θ}} ] - E [ \dot{s} ] E [ \frac{1}{{\dot{θ}}^{2}} ] & if \vert \dot{θ} \vert > {ε}_{\dot{θ}} \\ E [ {s}_{0} τ + \frac{1}{2} \dot{s} {τ}^{2} ] E [ cos \dot{θ} τ ] & otherwise\end{matrix} & Eq . 52\end{matrix}$$

Since E[\dot{s}]=0,

$$\begin{matrix}E [ {x}_{1} ] = {x}_{0} + \{ \begin{matrix}- {s}_{0} E [ \frac{cos \dot{θ} τ}{\dot{θ}} ] + {s}_{0} E [ \frac{1}{\dot{θ}} ] & if \vert \dot{θ} \vert > {ε}_{\dot{θ}} \\ {s}_{0} τ E [ sin \dot{θ} τ ] & otherwise\end{matrix} = {x}_{0} + \{ \begin{matrix}{s}_{0} E [ \frac{1 - cos \dot{θ} τ}{\dot{θ}} ] & if \vert \dot{θ} \vert > {ε}_{\dot{θ}} \\ {s}_{0} τ E [ sin \dot{θ} τ ] & otherwise\end{matrix} & Eq . 53 \\ E [ {y}_{1} ] = {y}_{0} + \{ \begin{matrix}{s}_{0} E [ \frac{sin \dot{θ} τ}{\dot{θ}} ] & if \vert \dot{θ} \vert > {ε}_{\dot{θ}} \\ {s}_{0} τ E [ cos \dot{θ} τ ] & otherwise\end{matrix} & Eq . 54\end{matrix}$$

The expected values in Eq. 51 and Eq. 52 can be written as:

$$\begin{matrix}E [ {x}_{1} ] = {x}_{0} + {s}_{0} [ \begin{matrix}{\int }_{- \dot{Θ}}^{- {ε}_{\dot{θ}}} ( \frac{1}{2 \dot{Θ}} ) ( \frac{1 - cos \dot{θ} τ}{\dot{θ}} ) d \dot{θ} + \\ τ {\int }_{- {ε}_{\dot{θ}}}^{+ {ε}_{\dot{θ}}} ( \frac{1}{2 \dot{Θ}} ) sin \dot{θ} τ d \dot{θ} + \\ {\int }_{+ {ε}_{\dot{θ}}}^{+ \dot{Θ}} ( \frac{1}{2 \dot{Θ}} ) ( \frac{1 - cos \dot{θ} τ}{\dot{θ}} ) d \dot{θ}\end{matrix} ] & Eq . 55 \\ E [ {y}_{1} ] = {y}_{0} + {s}_{0} [ \begin{matrix}{\int }_{- \dot{Θ}}^{- {ε}_{\dot{θ}}} ( \frac{sin \dot{θ} τ}{\dot{θ}} ) ( \frac{1}{2 \dot{Θ}} ) d \dot{θ} + \\ {\int }_{- {ε}_{\dot{θ}}}^{+ {ε}_{\dot{θ}}} ( \frac{1}{2 \dot{Θ} } ) cos \dot{θ} τ d \dot{θ} + \\ τ {\int }_{- {ε}_{\dot{θ}}}^{+ \dot{Θ}} ( \frac{sin \dot{θ} τ}{\dot{θ}} ) ( \frac{1}{2 \dot{Θ}} ) d \dot{θ}\end{matrix} ] & Eq . 56\end{matrix}$$

These integrals are identical to the expected values for E[sin \dot{θ}τ], E]cos \dot{θ}τ],

$$E [ \frac{sin \dot{θ} τ}{\dot{θ}} ] , \\ and$$

$$E [ \frac{1 - cos \dot{θ} τ}{\dot{θ}} ]$$

that were found earlier, except now with different limits of integration. Within the limits now defined, each function is well-behaved with no infinities in the range. First consider E[x₁]. All three integrals in Eq. 55 do not need to be evaluated. Since the integrands are odd functions and symmetrical area is being integrated, the area must sum to zero. Therefore, all the integrals for E[x₁] are zero. Now consider E[y₁]. The second integral in Eq. 56 is identical to E[cos \dot{θ}τ] that was already evaluated in (Eq. 30) except with different limits:

$${\int }_{- {ε}_{\dot{θ}}}^{+ {ε}_{\dot{θ}}} ( \frac{1}{2 \dot{Θ}} ) cos \dot{θ} τ d \dot{θ} = ( \frac{1}{2 \dot{Θ} τ} ) sin \dot{θ} τ {\vert}_{- {ε}_{\dot{θ}}}^{+ {ε}_{\dot{θ}}} = ( \frac{1}{2 \dot{Θ} τ} ) ( sin {ε}_{\dot{θ}} τ + sin {ε}_{\dot{θ}} τ ) = \frac{sin {ε}_{\dot{θ}} τ}{\dot{Θ} τ} \qquad Eq . 57$$

The first and last integrals in Eq. 56 are similar to evaluating E[sin \dot{θ}τ/\dot{θ}].

$${\int }_{- \dot{Θ}}^{- {ε}_{\dot{θ}}} ( \frac{sin \dot{θ} τ}{\dot{θ}} ) ( \frac{1}{2 \dot{Θ}} ) d \dot{θ} + {\int }_{+ {ε}_{\dot{θ}}}^{+ \dot{Θ}} ( \frac{sin \dot{θ} τ}{\dot{θ}} ) ( \frac{1}{2 \dot{Θ}} ) d \dot{θ} = \frac{Si ( \dot{θ} τ )}{2 \dot{Θ}} {{\vert}_{- \dot{Θ}}^{- {ε}_{\dot{θ}}} + \frac{Si ( \dot{θ} τ )}{2 \dot{Θ}} \vert}_{+ {ε}_{\dot{θ}}}^{+ \dot{Θ}} = \frac{1}{2 \dot{Θ}} [ \begin{matrix}Si ( - {ε}_{\dot{θ}} τ ) - Si ( - \dot{Θ} τ ) + \\ Si ( \dot{Θ} τ ) - Si ( {ε}_{\dot{θ}} τ )\end{matrix} ] = \frac{1}{2 \dot{Θ}} [ \begin{matrix}- Si ( {ε}_{\dot{θ}} τ ) + Si ( \dot{Θ} τ ) + \\ Si ( \dot{Θ} τ ) - Si ( {ε}_{\dot{θ}} τ )\end{matrix} ] = \frac{1}{\dot{Θ}} [ Si ( \dot{Θ} τ ) - Si ( {ε}_{\dot{θ}} τ ) ] \qquad Eq . 58$$

Using these results in Eq. 55 and Eq. 56 the expected position using the modified motion equation is:

$$\begin{matrix}E [ {x}_{1} ] = {x}_{0} & Eq . 59 \\ E [ {y}_{1} ] = {y}_{0} + \frac{{S}_{k - 1}}{\dot{Θ}} [ Si ( \dot{Θ} τ ) - Si ( {ε}_{\dot{θ}} τ ) + sin {ε}_{\dot{θ}} τ ] & Eq . 60\end{matrix}$$

Since ∈_{\dot{θ}} is small, both Si(∈_{\dot{θ}}τ)≈0 and sin ∈_{\dot{θ}}τ≈0, so

$$E [ {y}_{1} ] \approx {y}_{0} + {s}_{0} \frac{Si ( \dot{Θ} τ )}{\dot{Θ}} .$$

Now consider the variance of the position. To avoid the issue of possible division by zero, the modification, Eq. 10 and 11 or 49 and 50, as well will be used to find the variance.

$$\begin{matrix}E [ {x}_{1}^{2} ] = E [ ( {x}_{0} + {\{ \begin{matrix}\frac{1}{{\dot{θ}}^{2}} [ \begin{matrix}\dot{s} sin {θ}_{1} - {s}_{1} \dot{θ} cos {θ}_{1} - \\ \dot{s} sin {θ}_{0} + {s}_{0} \dot{θ} cos {θ}_{0}\end{matrix} ] & if \vert \dot{θ} \vert > {ε}_{\dot{θ}} \\ ( {s}_{0} τ + \frac{1}{2} \dot{s} {τ}^{2} ) sin ( {θ}_{0} + \dot{θ} τ ) & otherwise\end{matrix} )}^{2} ] & Eq . 61 \\ E [ {y}_{1}^{2} ] = E [ ( {y}_{0} + {\{ \begin{matrix}\frac{1}{{\dot{θ}}^{2}} [ \begin{matrix}\dot{s} cos {θ}_{1} - {s}_{1} \dot{θ} sin {θ}_{1} - \\ \dot{s} cos {θ}_{0} + {s}_{0} \dot{θ} sin {θ}_{0}\end{matrix} ] & if \vert \dot{θ} \vert > {ε}_{\dot{θ}} \\ ( {s}_{0} τ + \frac{1}{2} \dot{s} {τ}^{2} ) sin ( {θ}_{0} + \dot{θ} τ ) & otherwise\end{matrix} )}^{2} ] & Eq . 62\end{matrix}$$

All of the integrals arising from these expected values are solvable but produce “messy” solutions. Thus, although a closed form solution can be found for the variance of the position, it is much too complicated to be useful. Therefore, the predicted state and covariance will be estimated using numerical methods as described next.

### The Mean and Variance of the Transition Density (Double Maneuver)

Now that the distribution parameters have been determined for the case when there is one maneuver over the update time interval, the case when there are two maneuvers is considered next. For this two-step case, assume the target starts with some randomly selected acceleration and turn rate and executes that maneuver for τ time, just as was assumed for the one-step case. But at time τ, the target randomly selects another acceleration and turn rate and executes that maneuver for the remainder of the update time interval, T−τ. This assumed process now makes τ a random variable as well. Maintaining consistency with the rest of the analysis, assume τ is a uniform random variable such that 0≦τ≦T. Therefore,

$$\begin{matrix}E [ τ ] = \frac{1}{2} T & Eq . 63 \\ Var [ τ ] = {σ}_{τ}^{2} = \frac{1}{12} {T}^{2} & Eq . 64\end{matrix}$$

To deal with the multiple maneuvers, the (randomly) selected accelerations and turn rates need to be subscripted as well. As before, assume at a specified update time, the target is at (x₀, y₀). Let this update time be at time zero. The (predicted) state of the target is desired for the next update time, T. Let τ be the time when the target finishes its first maneuver and starts its second (and last) maneuver over the time update interval. As before, the subscripts reflect target states within an update time interval. So (x₀, y₀) is the position of the target at the begin inning of the update time interval having initial speed s₀ and initial course θ₀. An acceleration \dot{s}₁ and turn rate, \dot{θ}₁, is (randomly) selected. The target would then have position (x₁, y₁) τ time later with speed s₁ and course θ₁. At this point in time, the target (randomly) selects a new acceleration and turn rate, \dot{s}₂ and \dot{θ}₂, respectively. The target executes that maneuver for the remainder of the update time interval, T−τ. At the end of the update time period, T, the target would have position (x₂, y₂) with speed and course s₂ and θ₂, respectively. Using this notation,

$$\begin{matrix}{s}_{1} = {s}_{0} + {\dot{s}}_{1} τ & Eq . 65 \\ {s}_{2} = {s}_{1} + {\dot{s}}_{2} ( T - τ ) = {s}_{0} + {\dot{s}}_{1} τ + {\dot{s}}_{2} ( T - τ ) & Eq . 66 \\ {θ}_{1} = {θ}_{0} + {\dot{θ}}_{1} τ & Eq . 67 \\ {θ}_{2} = {θ}_{1} + {\dot{θ}}_{2} ( T - τ ) = {θ}_{0} + {\dot{θ}}_{1} τ + {\dot{θ}}_{2} ( T - τ ) & Eq . 68 \\ {\dot{x}}_{1} = {s}_{1} sin {θ}_{1} & Eq . 69 \\ {\dot{x}}_{2} = {s}_{2} sin {θ}_{2} & Eq . 70 \\ {\dot{y}}_{1} = {s}_{1} cos {θ}_{1} & Eq . 71 \\ {\dot{y}}_{2} = {s}_{2} cos {θ}_{2} & Eq . 72 \\ {x}_{1} = {x}_{0} + \frac{1}{{\dot{θ}}_{1}^{2}} [ {\dot{s}}_{1} sin {θ}_{1} - {s}_{1} {\dot{θ}}_{1} cos {θ}_{1} - {\dot{s}}_{1} sin {θ}_{0} + {s}_{0} {\dot{θ}}_{1} cos {θ}_{0} ] & Eq . 73 \\ {x}_{2} = {x}_{1} + \frac{1}{{\dot{θ}}_{2}^{2}} [ {\dot{s}}_{2} sin {θ}_{2} - {s}_{2} {\dot{θ}}_{2} cos {θ}_{2} - {\dot{s}}_{2} sin {θ}_{1} + {s}_{1} {\dot{θ}}_{2} cos {θ}_{1} ] & Eq . 74 \\ {y}_{1} = {y}_{0} + \frac{1}{{\dot{θ}}_{1}^{2}} [ {\dot{s}}_{1} cos {θ}_{1} - {s}_{1} {\dot{θ}}_{1} sin {θ}_{1} - {\dot{s}}_{1} cos {θ}_{0} + {s}_{0} {\dot{θ}}_{1} sin {θ}_{0} ] & Eq . 75 \\ {y}_{2} = {y}_{1} + \frac{1}{{\dot{θ}}_{2}^{2}} [ {\dot{s}}_{2} cos {θ}_{2} - {s}_{2} {\dot{θ}}_{2} sin {θ}_{2} - {\dot{s}}_{2} cos {θ}_{1} + {s}_{1} {\dot{θ}}_{2} sin {θ}_{1} ] & Eq . 76\end{matrix}$$

### The Mean and Variance of the Speed and Course

To find the mean and variance of the speed and course for the two-maneuver case, note that it is necessary to deal with a product of independent random variables. It is known that the variance of a product of independent random variables, A, B is given by:

Var[AB]=(E[A])²Var[B]+(E[B])²Var[A]+Var[A]Var[B] Eq. 77

Using this property along with

$$E [ {\dot{s}}_{1} ] = E [ {\dot{s}}_{2} ] = E [ {\dot{θ}}_{1} ] = E [ {\dot{θ}}_{2} ] = 0 , \\ E [ T - τ ] = E [ τ ] = \frac{1}{2} T , \\ Var [ {\dot{s}}_{1} ] = Var [ {\dot{s}}_{2} ] = {σ}_{\dot{s}}^{2} , \\ and$$

$$Var [ T - τ ] = Var [ τ ] = {σ}_{τ}^{2} = \frac{1}{12} {T}^{2} , \\ then$$

$$\begin{matrix}\begin{matrix}E [ {s}_{2} ] = E [ {s}_{0} ] + E [ {\dot{s}}_{1} τ ] + E [ {\dot{s}}_{2} ( T - τ ) ] \\ = {s}_{0} + E [ {\dot{s}}_{1} ] E [ τ ] + E [ {\dot{s}}_{2} ] E [ T - τ ] \\ = {s}_{0}\end{matrix} & Eq . 78 \\ \begin{matrix}Var [ {s}_{2} ] = Var [ {s}_{0} ] + Var [ {\dot{s}}_{1} τ ] + Var [ {\dot{s}}_{2} ( T - τ ) ] \\ = \{ \begin{matrix}{( E [ {\dot{s}}_{2} ] )}^{2} Var [ τ ] + {( E [ τ ] )}^{2} Var [ {\dot{s}}_{1} ] + \\ Var [ {\dot{s}}_{1} ] Var [ τ ]\end{matrix} \} + \\ \{ \begin{matrix}{( E [ {\dot{s}}_{2} ] )}^{2} Var [ T - τ ] + \\ {( E [ T - τ ] )}^{2} Var [ {\dot{s}}_{2} ] + Var [ {\dot{s}}_{2} ] Var [ T - τ ]\end{matrix} \} \\ = 2 [ {( \frac{1}{2} T )}^{2} {σ}_{\dot{s}}^{2} + {σ}_{\dot{s}}^{2} ( \frac{1}{12} {T}^{2} ) ] = \frac{2}{3} {T}^{2} {σ}_{\dot{s}}^{2}\end{matrix} & Eq . 79 \\ \begin{matrix}E [ {θ}_{2} ] = E [ {θ}_{0} ] + E [ {\dot{θ}}_{1} τ ] + E [ {\dot{θ}}_{2} ( T - τ ) ] \\ = {θ}_{0} + E [ {\dot{θ}}_{1} ] E [ τ ] + E [ {\dot{θ}}_{2} ] E [ T - τ ] \\ = {θ}_{0}\end{matrix} & Eq . 80 \\ \begin{matrix}Var [ {θ}_{2} ] = Var [ {θ}_{0} ] + Var [ {\dot{θ}}_{1} τ ] + Var [ {\dot{θ}}_{2} ( T - τ ) ] \\ = \{ \begin{matrix}{( E [ {\dot{θ}}_{1} ] )}^{2} Var [ τ ] + {( E [ τ ] )}^{2} Var [ {\dot{θ}}_{1} ] + \\ Var [ {\dot{θ}}_{1} ] Var [ τ ]\end{matrix} \} + \\ \{ \begin{matrix}{( E [ {\dot{θ}}_{2} ] )}^{2} Var [ T - τ ] + \\ {( E [ T - τ ] )}^{2} Var [ {\dot{θ}}_{2} ] + Var [ {\dot{θ}}_{2} ] Var [ T - τ ]\end{matrix} \} \\ = 2 [ {( \frac{1}{2} T )}^{2} {σ}_{\dot{θ}}^{2} + {σ}_{\dot{θ}}^{2} ( \frac{1}{12} {T}^{2} ) ] = \frac{2}{3} {T}^{2} {σ}_{\dot{θ}}^{2}\end{matrix} & Eq . 81\end{matrix}$$

Comparing Eq. 78-80 to Eq. 19-22 shows the means for the speed and course for the two-maneuver case are the same as those for the one-maneuver case, but the variances for the two-maneuver case are smaller by two thirds. (Recall that τ=T for the one-maneuver case.)

### The Man and Variance of the State

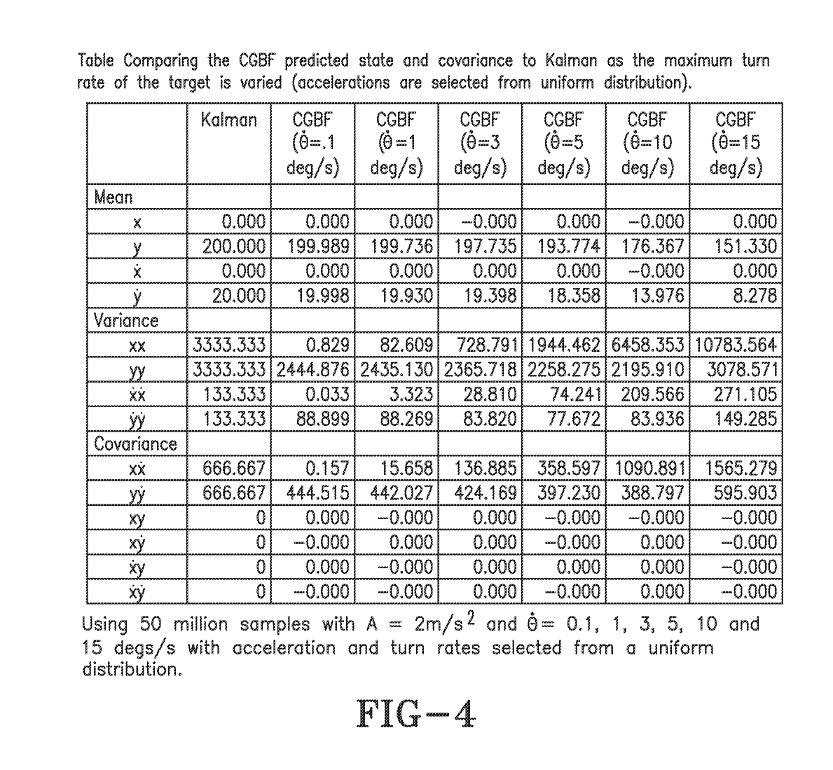

Determining the mean and variance of the state when the target undergoes two (kinematically-constrained) maneuvers is difficult to do in closed-form. However, these parameters can be approximated using Monte Carlos techniques. For the analysis, 50,000,000 samples were used. For all the cases, the target was initially at the origin moving due North at 20 m/s. The update time interval was T=10 s and the maximum acceleration was A=2 m/s². Thus, (x₀, y₀)=(0,0), s₀=20, and θ₀=0. The table in FIG. 4 compares the predicted state and covariance from the CGBF against the Kalman filter. Since the Kalman filter does not use turn rates, its predicted state and covariance do not change as the maximum turn rate is varied. However, as the table shows, these values vary dramatically depending on the maximum turn rate assumed for the target. For example, when the maximum turn rate is small, the CGBF predicted position is nearly identical to Kalman. But as the maximum turn rate increases to 15 deg/s, the y position diminishes from 200 m to ˜151 m, a nearly 25% reduction. The y component of the velocity reduces from 20 m/s to ˜8 m/s, which is more than 50% reduction. The variance terms show an interesting difference as well. The Kalman filter assumes the distribution is circular; no initial direction of the target is considered. As a result, it grossly overestimates the uncertainty perpendicular to the initial course of the target when it has a small turn rate. The target needs a turn rate over 10 deg/s for the magnitude of the uncertainty to be as large as the Kalman filter assumes. Finally, the covariance terms are very different. The Kalman filter only specifies two covariance terms: x position with the x velocity and y position with the y velocity. The other four covariance terms are assumed to be zero. As shown in the table, this is a reasonable assumption. The last four covariance terms are all near, or possibly equal to zero regardless of the maximum rate. However, the table shows that for the two covariance terms that the Kalman filter computes, they are quite different from the CGBF. The Kalman filters uses ˜667 m²/s for both x and y. The CGBF estimates the x\dot{x} covariance to be as small as ˜0.2 m²/s for a small maximum turn rate target to as large as ˜1565 m²/s for a high maximum turn rate target. Interestingly, the y\dot{y} covariance does not vary much relative to the maximum turn rate. For most turn rates, it stays around 400 m²/s, which is about 35% small than the corresponding Kalman value.

The state estimates are directly influenced by the predicted covariance. Sine the predicted covariance from the CGBF is tighter and more aligned to the real target state, it suggests that the CGBF should yield tighter and more accurate state estimates than the Kalman filter.

### Motion Update

Performing a motion predict is particularly computational for a GBF. Each cell in the grid must be propagated to all the other cells that the target could have transitioned to during the time to the next measurement update. These propagations are found by generating a large number of Monte Carlo samples for each cell in the grid. Since the grids tend to be large, an enormous number of Monte Carlo samples are required for each cell to form a good approximation of the cell's transition distribution.

To form the target starting position for each cell, there are two common approaches: 1) use the center position of the cell, or 2) randomly sample within the cell positional limits. Randomly sampling within the cell limits is usually a better approach because the true target position could be near an edge of the cell. If the cells are large compared to the distance the target moves in an update, then the errors introduced by only using the cell center could be significant. However, random sampling over the cell may require even more Monte Carlo sample per cell to get a good distribution over the entire cell.

With this invention, an alternative motion update procedure has been developed that has two key refinements over these two approaches. The first refinement is how the mass in the cells is transitioned. Current GBF approaches move the mass in a cell treating the cell state as a “point”, similar to a particle in a particle filter. In the CGBF, instead of moving a point within the cell, the entire cell region is moved per Monte Carlo sample. This is illustrated in FIG. 5. By moving the entire cell for each sample, there is more assurance of obtaining a good distribution over each origination cell, without the need to randomly sample within the cell limits.

Note from FIG. 5 that a transitioned cell from the origination grid will generally land across boundaries of cells within the destination grid. The probability in the transitioned origination cell is apportioned out to the destination cells based on the fractional coverage it receives (from the transitioned cell). The function CellOverlapFraction in FIG. 2 determines this fractional coverage. The cells do not need to be the same size from the origination grid to the destination grid. Each destination cell only gets the percentage of mass based on the portion of overlap. The second refinement exploits the motion symmetry to obtain two Monte Carlo samples from each sample made. This final refinement is detailed in the next section.

### Exploiting the Motion Symmetry

As was pointed out earlier, the transition distribution is symmetric with respect to the target's initial course. As a result, this symmetry can be exploited in the generation of the random samples. Each time the target is randomly moved throughout the time interval, the mirrored state can also be used as a sample. Thus, two random samples are generated for each random walk which results in 2 m samples being generated for the computational cost of generating m samples.

Let (x₀, y₀) be the (estimated) initial state of the target at the beginning of the update time interval and (xₖ, yₖ) be the final predicted state at the end of the time interval (by undergoing k maneuvers). Similarly, let s₀ and θ₀ be the initial speed and course and sₖ and θₖ be the predicted speed and course at the end of the interval. The mirrored state is defined as the resulting target state if it had simply reversed all its turns such that left turns become right turns, and vice versa. This mirrored state can be used as a second Monte Carlo sample for each sample actually computed. The mirrored state is straightforward to determine directly from the final state of the target after it completed all its maneuvers for the time interval.

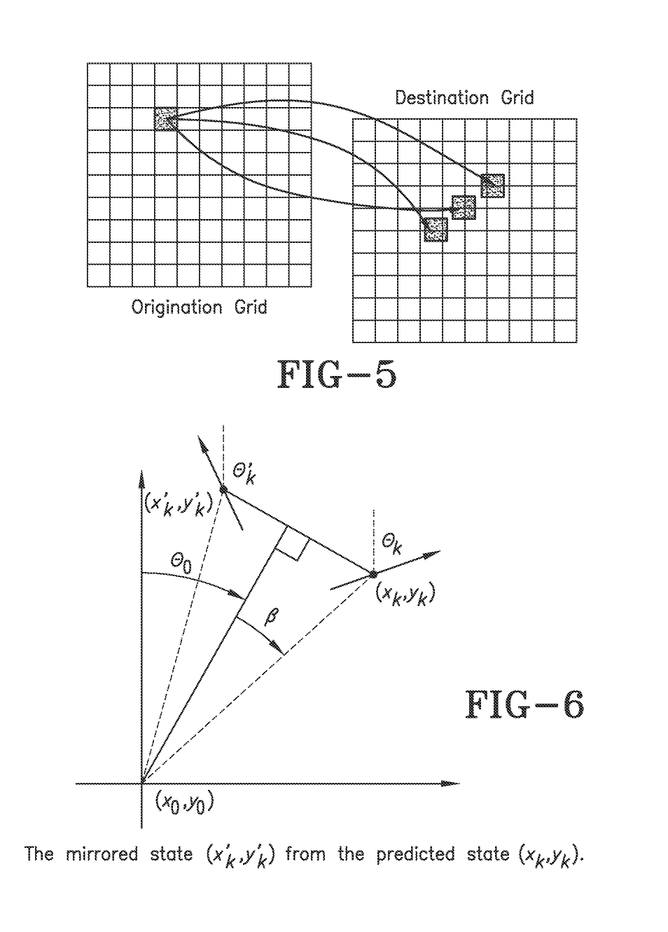

Referring to FIG. 6, the resulting target state is (xₖ, yₖ) at the end of time interval. The mirrored target state is (x′ₖ, y′ₖ) with speed s′ₖ and course θ′ₖ. Let β be the angle between the initial course of the target and the angle to the predicted state, (xₖ, yₖ). Let α=θ₀+β. Therefore, the mirrored position can be found as:

$$\begin{matrix}Δ x = {x}_{k} - {x}_{0} & Eq . 82 \\ Δ y = {y}_{k} - {y}_{0} & Eq . 83 \\ d = \sqrt{Δ {x}^{2} + Δ {y}^{2}} & Eq . 84 \\ sin α = \frac{Δ x}{d} & Eq . 85 \\ cos α = \frac{Δ y}{d} & Eq . 86 \\ {x}_{k}^{′} = {x}_{0} + d sin ( {θ}_{0} - β ) & Eq . 87 \\ {y}_{k}^{′} = {y}_{0} + d cos ( {θ}_{0} - β ) & Eq . 88\end{matrix}$$

### But θ₀'2β=θ₀−(θ₀+β)+θ₀=2θ₀−α. So,

$$\begin{matrix}\begin{matrix}{x}_{k}^{′} = {x}_{0} + d sin ( 2 {θ}_{0} - α ) \\ = {x}_{0} + d [ sin 2 {θ}_{0} cos α - cos 2 {θ}_{0} sin α ] \\ = {x}_{0} + d [ sin 2 {θ}_{0} \frac{Δ y}{d} - cos 2 {θ}_{0} \frac{Δ x}{d} ] \\ = {x}_{0} + Δ y sin 2 {θ}_{0} - Δ x cos 2 {θ}_{0}\end{matrix} & Eq . 89 \\ \begin{matrix}{y}_{k}^{′} = {y}_{0} + d cos ( 2 {θ}_{0} - α ) \\ = {y}_{0} + d [ cos 2 {θ}_{0} cos α - sin 2 {θ}_{0} sin α ] \\ = {y}_{0} + d [ cos 2 {θ}_{0} \frac{Δ y}{d} - sin 2 {θ}_{0} \frac{Δ x}{d} ] \\ = {y}_{0} + Δ y cos 2 {θ}_{0} - Δ x sin 2 {θ}_{0}\end{matrix} & Eq . 90\end{matrix}$$

Computing the mirrored speed and course is starightforward as well. By definition, the mirrored speed does not change; only the target's course. Let Δθ=θₖ'1θ₀ be the course difference from the initial course to the final course. Thus, the final course can be thought of as θₖ=θ₀+Δθ. The mirrored course must be θₖ=θ₀31 Δθ. Therefore the mirrored state is:

x ′ₖ=x₀+(yₖ−y₀)sin 2θ₀−(xₖ−x₀)cos 2θ₀ Eq. 91

y′ₖ=y₀+(yₖ−y₀)cos 7θ₀+(xₖ−x₀)sin 2θ₀ Eq. 93

s′ₖ=sₖ Eq. 93

θ′ₖ=θ₀−Δθ=θ₀−(θₖ−θ₀)=2θ₀−θₖ Eq. -b 94

### Using Uniform RVs to Approximate Normal RVs

Although many computer systems provide the ability to generate normal random variables, they typically require many more computations than the generation of uniform random variables. When performing the Monte Carlo sampling, the random variables must be drawn from a normal distribution (see FIG. 2). Fortunately, the CGBF sampling process does not need “true” normal random variables; they only need to be approximately normal. A simple approximation was developed for the CGBF to exploit this idea. The normal-like random variables are generated using the following procedure. Suppose a total of m random samples are needed where each random sample is drawn from a normal distribution with a specified standard deviation. The number of random samples is divided into thirds. Let k=m/3. Then:
generate k uniform random samples that are within one sigma,
generate k uniform random samples that are within two signma, and finally,
generate k uniform random samples that are within three sigma.

This method is called the thirds procedure. For a “true” (1D) normal random variable, ˜68.2% of the samples would be within one sigma, ˜95.4% are within two sigma, and ˜99.7% are within three sigma[12]. Using the approximating procedure just described,

$$k + \frac{1}{2} k + \frac{1}{3} k = \frac{k}{6} ( 6 + 3 + 2 ) = \frac{11}{6} ( \frac{m}{3} ) = ( 61.1 \% ) m$$

samples will be within one sigma,

$$k = k + \frac{2}{3} k = \frac{k}{3} ( 3 + 3 + 2 ) = \frac{8}{3} ( \frac{m}{3} ) = ( 88.8 \% ) m$$

samples will be within two sigma, and of course, 100% of the samples wil be within three sigma. These percentages are close enough to get the proper sampling. Thus, using this thirds procedure with uniform random variables, the needed normal random variables are efficiently obtained.

Although the invention has been described in detail with particular reference to these preferred embodiments, other embodiments can achieve the same results. Variations and modifications of the present invention will be obvious to those skilled in the art and it is the indent of this application to cover, in the appended claims, all such modifications and equivalents. The entire disclosure and all references, applications, patents and publications cited above are hereby incorporated by reference.

What is claimed is:

1. A computer program product embodied in a non-transitory computer-readable medium that provides state estimates for a maneuvering target using a multi-dimensional grid-based filter, comprising:
software instructions for enabling a computer to perform predetermined operations; and
a machine-readable medium bearing the software instructions, the predetermined operations comprising:
assuming given target kinematic constraints,
forming a first grid of cells, of a finite size and scale, wherein each cell corresponds to a particular rectangular region in a x and y coordinate system,
capturing possible target states using a first measurement, wherein each state is a position, course and speed of the target;
forming a second grid of cells of finite size and scale, wherein each cell corresponds to a particular rectangular region in an x and y coordinate to over a duration between the first measurement and a second measurement;
forming a predicted target state distribution in the second grid by sampling the possible target states represented in the first grid, wherein the predicted target state distribution is represented in the cells of the second grid, wherein each cell includes:
a probability that the target transitioned to the cell;
a mean speed that the target would have if it transitioned to the cell;
a speed variance that the target would have if it transitioned to the cell, wherein the speeds within each cell are assumed normally distributed having the mean speed and speed variance;
a mean course that the target would have if it transitioned to the corresponding rectangular region; and
a course variance that the target would have if it transitioned to the cell, wherein courses within each cell are assumed normally distributed having the mean course and course variance; and
forming a discretized probability distribution over all the cells in the second grid; and
substituting the second grid as first grid for a subsequent measurement.

2. The computer program product of claim 1, wherein the finite size and scale of each grid is based on a measurement error distribution associated with each grid, wherein the finite size of the grid is 20×20 cells or less.

3. The computer program product of claim 1, wherein the sampling simulates a different random maneuver of the target over a specified duration, and symmetry of the predicted state distribution is used to double the effect of the sampling.

4. The computer program product of claim 1, wherein cell-sized particles are transitioned from the first grid to the second grid during the sampling and the cell probability of the transitioned cell from the first grid is apportioned to the cells it overlaps in the second grid.

5. A method for providing state estimates for a maneuvering target using a multi-dimensional grid-based filter, comprising:
assuming given target kinematic constraints,
forming a first grid of cells, of a finite size and scale, wherein each cell corresponds to a particular rectangular region in an x and y coordinate system,
capturing possible target states using a first measurement, wherein each state is a position, course and speed of the target;
forming a second grid of cells of finite size and scale, wherein each cell corresponds to a particular rectangular region in an x and y coordinate system, comprising possible positions the target could have transitioned to over a duration between the first measurement and a second measurement;
forming a predicted target state distribution in the second grid by sampling the possible target states represented in the first grid, wherein the predicted target state distribution is represented in the cells of the second grid, wherein each cell includes:
a probability that the target transitioned to the cell;
a mean speed that the target would have if it transitioned to the cell;
a speed variance that the target would have if it transitioned to the cell, wherein the speeds within each cell are assumed normally distributed having the mean speed and speed variance;
a mean course that the target would have if it transitioned to the corresponding rectangular region; and
a course variance that the target would have if it transitioned to the cell, wherein courses within each cell are assumed normally distributed having the mean course and course variance; and
forming a discretized probability distribution over all the cells in the second grid; and
substituting the second grid as a first grid for a subsequent measurement.

6. The method of claim 5, wherein the finite size and scale of each grid is based on a measurement error distributing associated with each grid, wherein the finite size of the grid is 20×20 cells or less.

7. The method of claim 5, wherein the sampling simulates a different random maneuver of the target over a specified duration, and symmetry of the predicted state distribution is used to double the effect of the sampling.

8. The method of claim 5, wherein cell-sized particles are transitioned from the first grid to the second grid during the sampling and the cell probability of the transitioned cell from the first grid is apportioned to the cells it overlaps in the second grid.
